(19) United States
(12) Patent Application Publication
(10) Pub. No.: US 2014/0277763 A1
(43) Pub. Date: Sep. 18, 2014

(54) System for Controlling Building Services Based on Occupant

(71) Applicants: Joe Colett, Sherwood, OR (US); Tim Dobson, Grandville, MI (US); Sundeep Ramachandran, Trivandrum (IN)

(72) Inventors: Sundeep Ramachandran, Trivandrum (IN); Cara Bastoni, Bethlehem, PA (US); Tim Dobson, Grandville, MI (US); Joe Colett, Sherwood, OR (US); Tirumalai Tejas, Gandhinaga (IN)

(73) Assignees: Sundeep Ramachandran, Trivandrum (IN); Joe Colett, Sherwood, OR (US); Tim Dobson, Grandville, MI (US)

(21) Appl. No.: 14/205,188

(22) Filed: Mar. 11, 2014

Related U.S. Application Data
(60) Provisional application No. 61/782,928, filed on Mar. 14, 2013.

(51) Int. Cl. G05D 23/19

(52) U.S. Cl. CPC G05D 23/1917
USPC 700/276

(57) ABSTRACT

A system according to an illustrative embodiment includes an energy management system and a control system. The energy management system is configured to manage energy usage within a building. The control system is configured to determine an occupancy factor associated with the building, and control the energy management system according to the occupancy factor. The occupancy factor indicates a presence of electronic devices capable of wireless communications.

### CROSS-REFERENCE TO RELATED APPLICATIONS

The present application claims priority to and the benefit of U.S. Provisional Patent Application No. 61/782,928, filed Mar. 14, 2013, the entire disclosure of which is incorporated herein by reference.

### BACKGROUND

In the face of rising energy cost and environmental concerns, organizations and individuals are struggling to reduce energy use and minimize waste. One of the biggest sources of energy expenditure is services for commercial and academic buildings. These buildings require energy intensive functions such as providing heating, ventilation and air conditioning (HVAC), illumination and electricity for their occupants.

In order to reduce the cost of providing these services, modern buildings often implement measures to reduce energy waste. In many buildings, for example, lighting systems are automatically deactivated when there are no occupants in the vicinity. Likewise, temperature controls are often adjusted based on the time of the day and/or predetermined building schedules in order to reduce energy expenditure. These automated features can be accomplished with a building management system, which controls building functions such as lighting and HVAC.

A major challenge for automatic building energy management is reducing energy use without impairing occupancy comfort or convenience. For example, some building management systems will reduce HVAC functions during the times of the day when there are fewer occupants on average, such as in the early morning hours. Such a system may not sufficiently control the environment for building occupants during those hours. It would therefore be advantageous to provide an improved system for managing energy use within a building.

It may be advantageous to utilize information relating to building occupancy to provide more targeted energy control systems. There are several known methods for determining the presence of building occupants. One common device for detecting occupants in a room is a passive infrared (IR) sensor. This technology is usually used to control lighting systems. Passive IR sensors detect movement in rooms by sensing heat emitted by occupants. If no motion is detected for a pre-determined duration, then the lights in the room are deactivated. Alternatively, ultrasound sensors can also be used to detect occupancy. Ultrasound sensors emit a high frequency sound wave, and sense changes in the reflected sound caused by motion. There are several disadvantages for both of these systems. IR and ultrasound sensors need to be installed in every room of the building, which can be expensive. Furthermore, IR sensors may also be obstructed and fail to accurately detect occupancy. Additionally, IR and ultrasound sensors do not effectively detect the number of occupants in a room.

Carbon dioxide sensors are another technology used to detect building occupants. Carbon dioxide sensors have been used to control HVAC systems in some buildings. These sensors estimate occupant density by measuring the concentration of carbon dioxide inside the building. As occupant density increases, the concentration of exhaled carbon dioxide also increases. As with IR and ultrasound sensors, carbon dioxide sensors need to be installed throughout the building. The U.S. Department of Energy estimates that uninstalled sensors cost approximately $250 each and the total cost for installing one detection zone is approximately $700 to $1200. Thus, it can be very expensive to outfit an entire building with carbon dioxide sensors.

The cost of installing sensors prevents many organizations from adopting building management systems that detect occupancy. There is a need for systems that do not require extensive infrastructure changes or renovations. Therefore, a system that utilizes existing building infrastructure to detect occupancy would have the advantage of detecting occupancy in real-time without requiring extensive physical modifications or renovations.

### SUMMARY

In accordance with an embodiment, a system includes an energy management system and a control system. The energy management system is configured to manage energy usage within a building. The control system is configured to determine an occupancy factor associated with the building, wherein the occupancy factor indicates a presence of electronic devices capable of wireless communications, and control the energy management system according to the occupancy factor.

In an embodiment, the energy management system is configured to manage energy usage for a plurality of subsystems within the building, and wherein the plurality of subsystems comprises a heating, ventilation, and air condition (HVAC) system and a lighting system. In another embodiment, the occupancy factor indicates the presence and location of electronic devices that are capable of communicating via a wireless local area network (WLAN). The electronic devices may include badges or identification cards. In another embodiment, the electronic devices may include cell phones, computers, tablet devices, personal data assistants, or game consoles.

In an embodiment, the control system is further configured to determine a historical occupancy factor for the building, wherein the historical occupancy factor indicates historical occupancy trends based on a building location and time, and control the energy management system further according to the historical occupancy factor. In a further embodiment, the historical occupancy factor is based on a historical presence of WLAN-enabled devices, and the control system is configured to store over time a presence, location, and number of WLAN-enabled devices.

In an embodiment, the control system is further configured to control the energy management system further according to a building calendar, and the building calendar indicates a time and location of events that are scheduled within the building. In still another embodiment, the control system is further configured to determine an outside weather factor, wherein the outside weather factor indicates weather conditions outside of the building, and control the energy management system further according to the outside weather factor.

In an embodiment, the control system comprises a mobile device location tracking system that includes a received signal strength indication (RSSI) fingerprint component and a continuous signal broadcast component. The RSSI fingerprint comprises a dynamic dataset that associates pre-determined locations in the building with an RSSI signal strength, and the continuous signal broadcast component is configured to generate a signal of a constant, known strength at a fixed, known location. The control system is configured to adjust the RSSI fingerprint according to the signal generated by the continuous signal broadcast component.

In accordance with another embodiment, a method includes determining, by a computing system, an occupancy factor associated with a building, wherein the occupancy factor indicates a presence of electronic devices capable of wireless communications, and controlling, by the computing system, an energy management system according to the occupancy factor, wherein the energy management system is configured to manage energy usage within the building. In an embodiment, the energy management system is configured to manage energy usage for a plurality of subsystems within the building, and the plurality of subsystems include a heating, ventilation, and air condition (HVAC) system and a lighting system.

In an additional embodiment, the occupancy factor indicates the presence and location of electronic devices that are capable of communicating via a wireless local area network (WLAN). In further embodiments, the method further includes storing a presence, location, and number of WLAN-enabled devices over a period of time, determining a historical occupancy factor for the building, and controlling the energy management system further according to the historical occupancy factor. The historical occupancy factor indicates historical occupancy trends based on a building location and time, and the historical occupancy factor is based on a historical presence of the WLAN-enabled devices.

In another embodiment, the method also includes further controlling the energy management system according to a building calendar, wherein the building calendar indicates a time and location of events that are scheduled within the building. In still another embodiment, the method also includes determining an outside weather factor, wherein the outside weather factor indicates weather conditions outside of the building, and further controlling the energy management system according to the outside weather factor.

In an embodiment, the method also includes receiving a signal from a continuous signal broadcast component, and adjusting the RSSI fingerprint according to the received signal from the continuous signal broadcast component. The RSSI fingerprint includes a dynamic dataset that associates pre-determined locations in the building with an RSSI signal strength, and the received signal from the continuous signal broadcast component is generated at a constant, known strength and at a fixed, known location by the continuous signal broadcast component.

In accordance with another illustrative embodiment, a non-transitory computer-readable medium is provided that includes instructions stored thereon that, upon execution by a computing device, cause the computing device to perform various operations. Such operations include determining an occupancy factor associated with a building, wherein the occupancy factor indicates a presence of electronic devices capable of wireless communications, and controlling an energy management system according to the occupancy factor. The energy management system is configured to manage energy usage within the building. In an embodiment, the occupancy factor indicates the presence and location of electronic devices that are capable of communicating via a wireless local area network (WLAN).

### BRIEF DESCRIPTION OF THE FIGURES

FIG. 1 shows an overview of one embodiment of an energy management system.

FIG. 2 shows another exemplary embodiment of an energy management system.

FIG. 3 is an overview of a mobile device tracking system for determining the Occupancy Proxy [1] factor.

FIG. 4 is one example of how the mobile device tracking system functions.

FIG. 5 is another example of how the Mobile Device Location Tracking [8] algorithm might function.

FIG. 6 shows one example of how the Energy Management Algorithm [6] signals the BEMS [7] to control the HVAC system in a single room.

FIG. 7 shows one example of how the Energy Management Algorithm [6] controls the lighting system in a room.

FIG. 8 shows another example of how the Energy Management Algorithm [6] can control the lighting system in a particular room.

FIG. 9 shows an example of how the Energy Management Algorithm [6] controls the receptacles in a particular room.

FIG. 10 shows another example of how the Energy Management Algorithm [6] controls the receptacles in a particular room.

### DETAILED DESCRIPTION

According to an exemplary embodiment, a system and/or method is provided that utilizes building occupancy detection to provide more accurate and efficient building energy system control.

Most academic and commercial buildings provide wireless local area networks (WLAN) that allow occupants to access the Internet, or other networks, wirelessly. Many individuals, especially students and office workers, carry devices that can access the internet through WLAN. These devices include laptop computers, ‘smart’ mobile phones, game consoles, personal data assistants, and other electronic devices. Individuals often carry these devices on their persons or keep them in close proximity. As such, the location of WLAN-enabled devices is highly indicative of the location of building occupants.

These mobile devices access the Internet through routers located in the building. In order to connect to these routers, the mobile devices broadcast a constant signal if the WLAN feature on the device is activated. This signal broadcast may be received by one or more routers throughout the building.

The ability to combine the WLAN infrastructure of a building with a building energy management system would represent an improvement over current technology, create cost savings for organizations, and hasten the adoption of building energy management technology.

A system for controlling a building's energy use is disclosed herein. The system described herein is comprised of a method of estimating the presence and location of building occupants and a process for managing a building's energy use.

Some embodiments of the present system also include physical modifications to the building to control specific energy functions.

Energy Management Algorithm refers to a process that controls energy use in a building. The Energy Management Algorithm helps reduce the building's total energy consumption while minimizing inconvenience and discomfort for the building's occupants. The Energy Management Algorithm may be carried out by one or more computing devices, dedicated computers, computer software, embedded control systems, a cloud computing environment, or other electronic devices.

The term “Building Energy Management System” (“BEMS”) refers to a system that controls electrical and mechanical functions for a building. The Building Energy Management System typically controls Heating Ventilation and Air Conditioning (HVAC) systems, lighting systems, and/or other power systems. The functions of the BEMS may be carried out by one or more computing devices, dedicated computers, computer software, embedded control systems, a cloud computing environment, or other electronic devices.

The term “router” refers to network device that receives and sends information through a network of electronic devices.

The term “Wireless Local Area Network” (“WLAN”) refers to a wireless network of two or more electronic devices. One example of a Wireless Local Area Network protocol is IEEE 802.11, commonly known as Wi-Fi™.

The term “WLAN-enabled device” refers to any electronic device that can receive and transmit wireless signals through WLAN. Examples of WLAN-enabled devices include cell phones, computers, tablet devices, personal data assistants, and game consoles.

The term “Media Access Control” (“MAC”) address refers to a unique identifier for WLAN-enabled devices. In particular, WLAN-enabled devices that operate in IEEE 802.11 compliant networks are assigned a unique identifier by their manufacturer. In this document, the term ‘MAC address’ may also refer to any form of unique identifier for WLAN-enabled devices, including, for example, Extended Unique Identifiers.

The term “Received Signal Strength Indication” (“RSSI”) refers to a measure of power in a received wireless signal. As used in this document, RSSI refers to any measure of received signal strength.

The term “float” refers to a system state that generates a binary output in response to a variable input. In an HVAC system, the variable input is temperature and the binary output is activation or deactivation of HVAC functions. For instance, if the HVAC system is functioning in a float state, then the HVAC system activates to heat the building if the building temperature falls below a preset minimum. Likewise, the HVAC system will activate to cool the building if the building temperature exceeds a preset maximum. The HVAC system will be deactivated if the building temperature remains between the present minimum and preset maximum.

FIG. 1 shows an overview of one embodiment of an energy management system. Many commercial and academic buildings use a centralized system to control energy use. This centralized control system is commonly known as a Building Energy Management System [7] (BEMS). The BEMS [7] controls one or more sub-systems, which may include HVAC, illumination, power receptacles, and other building functions. FIG. 1 illustrates a system in which the BEMS [7] is partially or completely controlled by an Energy Management Algorithm [6].

In FIG. 1, the Energy Management Algorithm [6] signals the BEMS [7] to control certain building functions. For example, the Energy Management Algorithm [6] may signal the BEMS [7] to activate or deactivate the HVAC system in one portion of a building. Likewise, the Energy Management Algorithm [6] may also signal the BEMS [7] to activate or deactivate lights in one portion of the building. This signal may be in the form of, for example, electronic information or instructions. Additionally, the Energy Management Algorithm [6] may also signal the BEMS [7] to activate or deactivate receptacles in one portion of the building. These examples are not comprehensive, but merely illustrate some of the ways that the Energy Management Algorithm [6] may signal the BEMS [7].

The Energy Management Algorithm [6] processes multiple inputs to determine how it should signal the BEMS [7]. These inputs may include the Occupancy Proxy [1] factor, the Historical Occupancy [2] factor, the Building Calendar [3] factor, the Current Time [4] factor, and the Outside Weather [5] factor. The Energy Management Algorithm [6] uses these factors to determine how it should signal the BEMS [7].

The Occupancy Proxy [1] factor is an approximate measure of the presence and location of building occupants. In one example, the Occupancy Proxy [1] factor indicates the presence and location of electronic devices that are capable of transmitting and receiving information through WLAN. Many individuals carry electronic devices that can transmit and receive information through WLAN. Examples of WLAN-enabled devices include cell phones, computers, tablet devices, personal data assistants, and game consoles. The presence and location of WLAN-enabled devices may be indicative of the presence and location of building occupants. In other words, the Occupancy Proxy [1] factor is an approximation of the presence and location of building occupants because it measures the presence and location of WLAN-enabled devices.

In another example, the Occupancy Proxy [1] factor approximates the presence and location of building occupants by detecting the presence and location of badges or identification cards carried by building occupants. In many academic and commercial buildings, building occupants carry badges or identification cards. These badges or identification cards may also contain a wireless transmission device. Radio Frequency Identification chips represent one transmission device that can be embedded in badges or identification cards. Alternatively, the badges or identification cards may also transmit and receive information through WLAN. In this example, the Occupancy Proxy [1] factor is an approximation of the presence and location of building occupancy because it indicates the presence and location of badges or identification cards carried by building occupants.

The Historical Occupancy [2] factor indicates historical occupancy trends based on building location and time. For example, the Historical Occupancy [2] factor may show that a specific room is rarely occupied between the hours of 2:00 am to 6:00 am, and may also show that the same room is normally occupied from 9:00 am to 11:00 am. The Historical Occupancy [2] may also be used to generate information and/or reports of building occupancy patterns.

In one example, the Historical Occupancy [2] factor is determined by the historical presence of WLAN-enabled devices. In this example, the presence, location, and number of WLAN-enabled devices is stored over time. This record is used to determine the Historical Occupancy [2] factor.

The Building Calendar [3] factor indicates events that are scheduled for particular rooms or sections of a building. This factor indicates the time and place that events, such as meetings or classes, are scheduled.

The Current Time [4] factor indicates the current time of day. In one example, this factor is governed by an internal clock. In another example, this factor is determined by radio signals that indicate current time.

The Outside Weather [5] factor indicates the temperature and weather conditions outside of the building. In one example, the temperature and weather conditions are received through the Internet.

FIG. 2 shows another exemplary embodiment of an energy management system. In the embodiment shown in FIG. 2, the Energy Management Algorithm [6] controls the lighting system and receptacle system directly. In many academic and commercial buildings, similar electrical loads in a designated area are connected to the electrical system through a single relay. For example, some or all of the lighting in a room may be supplied by the same circuit. The Energy Management Algorithm [6] can control the lighting and receptacles in a room by switching this relay on and off. In buildings with existing lighting control relays, the control circuit of the existing relay can be connected to a separate controller and amplification circuit that receives commands from Energy Management Algorithm [6]. The output from the controller is an electrical signal which is amplified and sent to the relay. The relay changes state or remains in its last state depending on the input signal from the controller.

Alternatively, a separate relay can be installed between the circuit breaker and the circuit supplying power to the lights or receptacles of a room. Conventional electromechanical relays may be used. If conventional electromechanical relays are used, the non-energized state of the relay is Normally Closed (NC). Under this configuration, power flows to the lighting load and receptacles. If the Energy Management Algorithm [6] signals the relay to shut off power to the lights and receptacles, then the relay is energized and switches to the Normally Open (NO) state. This opens the circuit, which turns off all the lighting loads and receptacles connected to the circuit. Alternatively, latching relays may also be used to minimize the power drawn by the relay.

FIG. 3 is an overview of a mobile device tracking system for determining the Occupancy Proxy [1] factor. In this system, the Mobile Device Location Tracking [8] algorithm determines the presence and location of WLAN-enabled devices to approximate the presence and location of building occupants. Examples of WLAN-enabled devices include cell phones, computers, tablet devices, personal data assistants, and game consoles. The mobile device tracking system comprises a plurality of routers, a Continuous Signal Broadcast [10], an RSSI Fingerprint [11], and a Mobile Device Location Tracking [8] algorithm.

The RSSI Fingerprint [11] is a dynamic dataset that associates pre-determined locations in the building with RSSI signal strength. To create a RSSI Fingerprint [11], a number of routers are first placed in the building. Next, a calibration device will broadcast a set WLAN signal at predetermined locations in the building. These predetermined locations are called RSSI Nodes. In some embodiments, the RSSI Nodes form a grid, as shown in FIG. 4. The routers will detect RSSI from the calibration device at each RSSI node. Each router will then send the RSSI from the calibration device at each RSSI node to a central database.

The RSSI for WLAN-enabled device may be influenced by factors that are not related to the distance between the WLAN-enabled device and the router. For example, human bodies or other objects may interfere with the broadcast of WLAN signals. The signal interference is often random, or may depend upon the number, size and movement of occupants in the building. As such, a router may detect a varying RSSI value from a WLAN-enabled device because conditions in the building have changed, and not because the device has been relocated. Therefore, the RSSI Fingerprint [11] needs to adapt to changing conditions in the building.

In order to adapt the RSSI Fingerprint [11] to changing conditions in the building, the mobile device tracking system employs a Continuous Signal Broadcast [10]. The Continuous Signal Broadcast [10] is generated by a stand-alone WLAN broadcast device. The Continuous Signal Broadcast [10] is generated at a fixed, known location and at a constant, known strength. The Continuous Signal Broadcast [10] functions as a control variable for the mobile device tracking system. The RSSI from the Continuous Signal Broadcast [10] will vary in response to changing conditions in the room. Therefore, the RSSI from the Continuous Signal Broadcast [10] will be used to adjust the RSSI Fingerprint [11] in response to changes in the building that might alter WLAN signal transmission.

The following example illustrates how the Continuous Signal Broadcast [10] may be used to adjust the RSSI Fingerprint [11]. Suppose that, in an empty room, the signal strength from the Continuous Signal Broadcast [10] is valued at −35. As more occupants enter the room, suppose that the signal strength from the Continuous Signal Broadcast falls to a value of −60. In this example, the change in signal strength is 25. The RSSI Fingerprint [11] may account for this variation in signal strength. In some examples, the RSSI Fingerprint [11] may account for variations in signal strength with probabilistic algorithms.

In order to detect the presence and location of WLAN-enabled devices, the routers detect the RSSI and MAC address of any WLAN-enabled device in its vicinity. The MAC address is used to identify the WLAN-enabled device. Each router sends the RSSI and MAC address to the Mobile Device Location Tracking [8] algorithm, which may operate on a computing device, in a cloud computing environment, or on another electronic device. The Mobile Device Location Tracking [8] algorithm groups RSSIs together by MAC address. In some embodiments, the MAC address may be encrypted to protect the identity of the carrier of the WLAN-enabled device.

The Mobile Device Location Tracking [8] algorithm compares the RSSIs associated with each MAC address to the RSSI Fingerprint [11]. Each MAC address is assigned to the RSSI Node that is the closet match to the RSSIs associated with the MAC address using deterministic or probabilistic algorithms. Hence, each MAC address is associated with a location in the building.

FIG. 4 is one example of how the mobile device tracking system functions. In this example, the RSSI Nodes [12] are located at each intersection of the gridlines. The RSSI Fingerprint [11] is comprised of RSSIs associated with each node. There is a WLAN-enabled device, ‘Mobile Device 1 [9]’, in Room 2.

In this example, Router 1, Router 2 and Router 3 detect the RSSI and MAC address of Mobile Device 1 [9]. All three routers will send the information to the Mobile Device Location Tracking [8] algorithm. The Mobile Device Location Tracking [8] algorithm groups the RSSIs by the MAC address of Mobile Device 1 [9]. The system will compare the RSSIs from Mobile Device 1 [9] with the RSSI Fingerprint, and determine which RSSI Node is the closest to Mobile Device 1 [9] using deterministic or probabilistic algorithms. Mobile Device 1 [9] is assigned to the closest RSSI Node [13]. Through this process, the Mobile Device Location Tracking [8] algorithm recognizes one WLAN-enabled device in Room 2, and does not recognize any WLAN-enabled devices in Room 1, Room 3, or Room 4.

FIG. 5 is another example of how the Mobile Device Location Tracking [8] algorithm might function. In this example, the RSSI Nodes [12] are located at each intersection of the gridlines. The RSSI Fingerprint is comprised of RSSIs associated with each RSSI node. There are two WLAN-enabled computers, ‘Laptop 1’ and ‘Laptop 2’, located in Room 1. There is another WLAN-enabled device, ‘Mobile Device 1 [9]’ in Room 3.

In this example, Router 1, Router 2 and Router 3 all detect the RSSI and MAC address of Laptop 1, Laptop 2, and Mobile Device 1 [9]. The routers will send the RSSIs and MAC addresses of each device to the Mobile Device Location Tracking [8] algorithm. The algorithm [8] will compare the RSSIs from Laptop 1, Laptop 2, and Mobile Device 1 [9] with the RSSI Fingerprint [11] using deterministic or probabilistic algorithms. The Mobile Device Location Tracking [8] algorithm will assign each WLAN-enabled device to the RSSI node that is closest to the WLAN-enabled device. Through this process, the Mobile Device Location Tracking [8] algorithm recognizes two WLAN-enabled devices in Room 1, one WLAN-enabled device in Room 3, and does not recognize any WLAN-enabled devices in Room 2 or Room 4.

FIG. 6 shows one example of how the Energy Management Algorithm [6] signals the BEMS [7] to control the HVAC system in a single room. First, the Energy Management Algorithm [6] determines the number of WLAN-enabled devices in the room. The system compares the number of WLAN-enabled devices in a room to a pre-determined number. If the number of WLAN-enabled devices is greater than the predetermined number, then the system will signal the BEMS [7] to activate the HVAC system to the room. In this example, the predetermined number is 5. In other words, the Energy Management Algorithm [6] in this example will signal the BEMS [7] to activate the HVAC system if there are more than 5 WLAN-enabled devices. In another example, the system may signal the BEMS [7] to activate the HVAC system if there are one or more WLAN-enabled devices in the room.

If the number of WLAN-enabled devices is equal to, or less than, the pre-determined number, then the Energy Management Algorithm [6] determines if there are any events scheduled in the room within a set time, such as, for example, within two hours. In the example shown in FIG. 6, if there is an event scheduled in two hours, then the Energy Management Algorithm [6] will signal the BEMS [7] to precondition the room before the scheduled event. Pre-conditioning refers to the process of activating the HVAC system before anyone occupies the room in order to achieve a comfortable temperature when occupants arrive. The amount of time required for preconditioning depends on the outside temperature. If the outside temperature is very cold or very hot, then the HVAC system will likely need more time to adjust room temperature to a comfortable level.

In this example, if there is an event scheduled within two hours, and the outside temperature is either below 60° F. or above 80° F., then the Energy Management Algorithm [6] will signal the BEMS [7] to activate HVAC in the room. If there is an event scheduled within two hours, and the outside temperature is between 60° F. and 80° F., then the Energy Management Algorithm [6] will signal the BEMS [7] to activate HVAC in the room one hour before the scheduled event. The lower temperature and upper temperature threshold are illustrative, and may be set at other temperatures.

If there are no WLAN-enabled devices in this portion of the building and no events scheduled within two hours, then the Energy Management Algorithm [6] will determine, based on Historical Occupancy [2] data, whether the average number of occupants in the room exceeds a pre-determined number in the next two hours. Any time of the day in which, based on Historical Occupancy [2], the average number of occupants in the room exceeds the pre-determined number of occupants may be defined as a high occupancy time.

In the example shown in FIG. 6, a high occupancy time is any time of the day in which, based on Historical Occupancy [2], the average number of occupants in the room exceeds 14 people. If a high occupancy time is within two hours, then the Energy Management Algorithm [6] will signal the BEMS [7] to precondition the room before the high occupancy time. In this example, if the high occupancy time is within two hours, and the outside temperature is either below 60° F. or above 80° F., then the Energy Management Algorithm [6] will signal the BEMS [7] to activate the HVAC in the room. If a high occupancy time is within two hours, and the outside temperature is between 60° F. and 80° F., then the Energy Management Algorithm [6] will signal the BEMS [7] to activate HVAC in the room one hour before high occupancy time.

If there are no WLAN-enabled devices in the room, no events scheduled within two hours, and there is no high occupancy time within the next two hours, then the Energy Management Algorithm [6] will signal the BEMS [7] to float the HVAC system in the room. If the HVAC system is functioning in a float state, then the HVAC system will activate if the building temperature drops below a preset minimum. The HVAC system will also activate if the building temperature exceeds a preset maximum. The HVAC system will be deactivated if the building temperature hovers between the present minimum and preset maximum.

The threshold values used in this example are merely illustrative. It should be apparent to a person having ordinary skill in the art that the threshold values can be adjusted or changed. For instance, the Energy Management Algorithm [6] could signal the BEMS [7] to activate HVAC to the room when there is one or more WLAN-enabled devices detected in the room. Likewise, the time, temperature, and occupancy thresholds can all be adjusted accordingly.

FIG. 7 shows one example of how the Energy Management Algorithm [6] controls the lighting system in a room. The Energy Management Algorithm [6] can control the lighting system directly, or it can control the lighting system indirectly by signaling the BEMS [7] to control the lighting system. In some examples, the lighting system also allows occupants to control lights manually, such as by activating or deactivating a light switch.

In the example shown in FIG. 7, the Energy Management Algorithm [6] determines the number of WLAN-enabled devices in the room. If there are between one and five WLAN-enabled devices in the room, then the system will activate the lighting system in the room at 50%. If there are more than five WLAN-enabled devices in the room, then the Energy Management Algorithm [6] will activate the lighting system in the room at 100%.

In another example, the Energy Management Algorithm [6] determines the number of WLAN-enabled devices in the room. If there are one or more WLAN-enabled devices detected in the room, then the system will activate the lighting system in the room at 100%.

If there are no WLAN-enabled devices in this portion of the building, then the Energy Management Algorithm [6] will deactivate the lights if they are on, and do nothing if the lights are already off.

The threshold values used in this example are merely illustrative. It should be apparent to a person having ordinary skill in the art that the threshold values can be adjusted or changed. For instance, the Energy Management Algorithm [6] could activate the lights to 100% if there are any WLAN-enabled devices detected in the room.

FIG. 8 shows another example of how the Energy Management Algorithm [6] can control the lighting system in a particular room. The Energy Management Algorithm [6] can control the lighting system directly, or it can control the lighting system indirectly by signaling the BEMS [7] to control the lighting system.

In the example shown in FIG. 8, the Energy Management Algorithm [6] determines the number of WLAN-enabled devices in the room. If there are between one and five WLAN-enabled devices in the room, then the system will activate the lighting system in the room at 50%. If there are more than five WLAN-enabled devices in the room, then the Energy Management Algorithm [6] will activate the lighting system in the room at 100%.

In another example, the Energy Management Algorithm [6] determines the number of WLAN-enabled devices in the room. If there are one or more WLAN-enabled devices in the room, then the system will activate the lighting system in the room at 100%.

If there are no WLAN-enabled devices in this portion of the building, then the Energy Management Algorithm [6] will determine the Current Time [4]. If the Current Time [4] is within a predefined time period; such as, for example, after 12 am and before 5 am; then the Energy Management Algorithm [6] will turn off the lights if they are on. If the Current Time [4] is outside of the predefined time period; such as, for example, after 5 am and before 12 am, then the Energy Management Algorithm [6] will do nothing.

The threshold values used in this example are merely illustrative. It should be apparent to a person having ordinary skill in the art that the threshold values can be adjusted or changed.

FIG. 9 shows an example of how the Energy Management Algorithm [6] controls the receptacles in a particular room. The Energy Management Algorithm [6] can control the receptacles directly, or it can control the receptacles indirectly by signaling the BEMS [7] to control the receptacles system. First, the Energy Management Algorithm [6] determines if there are any WLAN-enabled devices in the room. In this example, if there are one or more WLAN-enabled devices present, then the Energy Management Algorithm [6] activates the receptacles.

If the Energy Management Algorithm [6] does not detect any WLAN-enabled devices in the room, then the Energy Management Algorithm [6] will determine if there are any events scheduled in the room. The Energy Management Algorithm [6] will activate receptacles if there are any events scheduled in the room. If the Energy Management Algorithm [6] does not detect WLAN-enabled devices in the room, and there are no events scheduled in the room, then the Energy Management Algorithm [6] will shut down the receptacles in the room.

Alternatively, if the Energy Management Algorithm [6] does not detect WLAN-enabled devices in the room, and there are no events scheduled in the room, then the Energy Management Algorithm [6] will shut down a portion of the receptacles in the room.

FIG. 10 shows another example of how the Energy Management Algorithm [6] controls the receptacles in a particular room. The Energy Management Algorithm [6] can control the receptacles directly, or it can control the receptacles indirectly by signaling the BEMS [7] to control the receptacles system. First, the Energy Management Algorithm [6] determines if there are any WLAN-enabled devices in the room. If there are any WLAN-enabled devices present, then the Energy Management Algorithm [6] activates the receptacles.

If the Energy Management Algorithm [6] does not detect any WLAN-enabled devices in the room, then the Energy Management Algorithm [6] will determine if there are any events scheduled in the room. The Energy Management Algorithm [6] will activate receptacles if there are any events scheduled in the room

If the Energy Management Algorithm [6] does not detect WLAN-enabled devices in the room, and there are no events scheduled in the room, then the Energy Management Algorithm [6] will determine the Current time [4]. If the Current Time [4] is within a predefined time period; such as, for example, after 12 am and before 5 am; then the Energy Management Algorithm [6] will deactivate the receptacles. If the Current Time [4] is outside of the predefined time period; such as for example, after 5 am and before 12 am; then the Energy Management Algorithm [6] will activate the receptacles.

The control functions of the various systems and controllers described herein can be implemented in digital electronic circuitry, or in computer software, firmware, or hardware, including the structures disclosed in this specification and their structural equivalents, or in combinations of one or more of them. The controls can be implemented as one or more computer programs, i.e., one or more modules of computer program instructions, encoded on one or more computer storage medium for execution by, or to control the operation of, data processing apparatus, such as a processing circuit. A processing circuit such as a CPU, for example, may comprise any digital and/or analog circuit components configured to perform the functions described herein, such as a microprocessor, microcontroller, application-specific integrated circuit, programmable logic, etc. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The controls, systems, methods, and algorithms described in this specification can be implemented as operations performed by a data processing apparatus on data stored on one or more computer-readable storage devices or received from other sources. The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., FPGA (field programmable gate array) or an ASIC (application specific integrated circuit). The apparatus can also include, in addition to hardware, code that creates an execution environment for the compute program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any, form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes, logic flows, and algorithms described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of the controls described herein may include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the control programs can be implemented on a computer having a display device, e.g., a CRT (cathode ray tube) or LCD (liquid crystal display) monitor, for displaying information to the user and a keyboard and an I/O device, e.g., a mouse or a touch sensitive screen, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be ion tracking system that includes a received signal strength indication (RSSI) fingerprint ent and with a user by sending documents to and receiving documents from a device that is used by the user; for example, by sending web pages to a web browser on a user's client device in response to requests received from the web browser.

Embodiments of the control programs, systems, methods, algorithms and processes described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), a wireless local area network (“WLAN”), on inter-network (e.g., the Internet), and peer-to-peer networks (e.g., ad hoc peer-to-peer networks).

The system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

As utilized herein, the terms “approximately,” “about,” “around,” “substantially,” and similar terms are intended to have abroad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” or “example of” as used herein to describe various embodiments is intended to indicate that such embodiments are possible examples, representations, and/or illustrations of possible embodiments (and such term is not intended to connote that such embodiments are necessarily extraordinary or superlative examples).

Features of any of the embodiments may be employed separately or in combination with any other feature(s) of the same or different embodiments and the disclosure extends to and includes all such arrangements whether or not described herein.

Other substitutions, modifications, changes and omissions may also be made in the design, operating conditions and arrangement of the various exemplary embodiments without departing from the scope of the inventions described herein. Other modifications that can be made will be apparent to those skilled in the art and the invention extends to and includes all such modifications. Any of the features described herein may be employed separately or in combination with any other feature and the invention extends to and includes any such feature or combination of features.

What is claimed is:

1. A system comprising:
an energy management system configured to manage energy usage within a building; and
a control system configured to:
determine an occupancy factor associated with the building, wherein the occupancy factor indicates a presence of electronic devices capable of wireless communications; and
control the energy management system according to the occupancy factor.

2. The system of claim 1, wherein the energy management system is configured to manage energy usage for a plurality of subsystems within the building, and wherein the plurality of subsystems comprises a heating, ventilation, and air condition (HVAC) system and a lighting system.

3. The system of claim 1, wherein the occupancy factor indicates the presence and location of electronic devices that are capable of communicating via a wireless local area network (WLAN).

4. The system of claim 1, wherein the electronic devices comprise badges or identification cards.

5. The system of claim 1, wherein the electronic devices comprise cell phones, computers, tablet devices, personal data assistants, or game consoles.

6. The system of claim 1, wherein control system is further configured to:
determine a historical occupancy factor for the building, wherein the historical occupancy factor indicates historical occupancy trends based on a building location and time; and
control the energy management system further according to the historical occupancy factor.

7. The system of claim 7, wherein the historical occupancy factor is based on a historical presence of WLAN-enabled devices, and wherein the control system is configured to store over time a presence, location, and number of WLAN-enabled devices.

8. The system of claim 1, wherein control system is further configured to control the energy management system further according to a building calendar, wherein the building calendar indicates a time and location of events that are scheduled within the building.

9. The system of claim 1, wherein control system is further configured to:
determine an outside weather factor, wherein the outside weather factor indicates weather conditions outside of the building; and
control the energy management system further according to the outside weather factor.

10. The system of claim 1, wherein the control system comprises a mobile device location tracking system that includes a received signal strength indication (RSSI) fingerprint component and a continuous signal broadcast component, wherein the RSSI fingerprint comprises a dynamic dataset that associates pre-determined locations in the building with an RSSI signal strength, and wherein the continuous signal broadcast component is configured to generate a signal of a constant, known strength at a fixed, known location.

11. The system of claim 10, wherein the control system is configured to adjust the RSSI fingerprint according to the signal generated by the continuous signal broadcast component.

12. A method comprising:
determining, by a computing system, an occupancy factor associated with a building, wherein the occupancy factor indicates a presence of electronic devices capable of wireless communications; and
controlling, by the computing system, an energy management system according to the occupancy factor, wherein the energy management system is configured to manage energy usage within the building.

13. The method of claim 12, wherein the energy management system is configured to manage energy usage for a plurality of subsystems within the building, and wherein the plurality of subsystems comprises a heating, ventilation, and air condition (HVAC) system and a lighting system.

14. The method of claim 12, wherein the occupancy factor indicates the presence and location of electronic devices that are capable of communicating via a wireless local area network (WLAN).

15. The method of claim 12, further comprising:
storing a presence, location, and number of WLAN-enabled devices over a period of time;
determining a historical occupancy factor for the building, wherein the historical occupancy factor indicates historical occupancy trends based on a building location and time, and wherein the historical occupancy factor is based on a historical presence of the WLAN-enabled devices; and
controlling the energy management system further according to the historical occupancy factor.

16. The method of claim 12, further comprising further controlling the energy management system according to a building calendar, wherein the building calendar indicates a time and location of events that are scheduled within the building.

17. The method of claim 12, further comprising:
determining an outside weather factor, wherein the outside weather factor indicates weather conditions outside of the building; and
further controlling the energy management system according to the outside weather factor.

18. The method of claim 12, further comprising:
receiving a signal from a continuous signal broadcast component; and
adjusting the RSSI fingerprint according to the received signal from the continuous signal broadcast component, wherein the RSSI fingerprint comprises a dynamic dataset that associates pre-determined locations in the building with an RSSI signal strength, and wherein the received signal from the continuous signal broadcast component is generated at a constant, known strength and at a fixed, known location by the continuous signal broadcast component.

19. A non-transitory computer-readable medium having instructions stored thereon that, upon execution by a computing device, cause the computing device to perform operations comprising:
determining an occupancy factor associated with a building, wherein the occupancy factor indicates a presence of electronic devices capable of wireless communications; and
controlling an energy management system according to the occupancy factor, wherein the energy management system is configured to manage energy usage within the building.

20. The non-transitory computer-readable medium of claim 19, wherein the occupancy factor indicates the presence and location of electronic devices that are capable of communicating via a wireless local area network (WLAN).
